(19) United States
(12) Patent Application Publication
(10) Pub. No.: US 2019/0016529 A1
(43) Pub. Date: Jan. 17, 2019

(54) BAGMASTER

(71) Applicant: JOHN GRACE, Plantation, FL (US)

(72) Inventor: JOHN GRACE, Plantation, FL (US)

(21) Appl. No.: 16/054,042

(22) Filed: Aug. 3, 2018

(51) Int. Cl. B65F 1/14

(52) U.S. Cl. CPC B65F 1/1415; B65F 2240/138

(57) ABSTRACT

The BAGMASTER is an re-usable durable, water-resistant, flexible sleeve placed inside inside trash/garbage bags to provide protection for the walls of the bags during the filling process while holding it open and upright to be filled.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Plastic bags used for collecting garbage and lawn waste come in a variety of thickness and strengths, while the thickest available on the market resist tearing they are not immune to it. Objects, sharp or otherwise, that puncture the wall of a plastic bag cause damage that cannot be repaired and when torn, depending upon the bag's thickness, the tear will “run”—get longer, the thin gauge more quickly and more extensively than the heavier gauge. Bags ripping is a problem encountered frequently by their users. The BAGMASTER offers a solution to this problem by protecting the plastic of the bag from the inside while it is being filled to avoid the bag from being easily ripped and punctured to allow the filling process to be completed.

The idea for the BAGMASTER developed during an autumn season while cleaning up the garden of dead grass, rose bush cuttings, branches and general trash. In filling the garden garbage bags two problems were encountered, firstly keeping the garbage bag open and upright and secondly the plastic garbage bag would rip when rose bush thorns, sticks or other sharp objects caught on its sides making the process of filling frustrating and time consuming.

To mitigate the two problems the idea to insert a resilient, reusable, moisture resistant, adjustable sleeve inside the garden garbage bag was conceived. Both of these problems have not been addressed in other inventions utilizing a device that is inserted inside the garbage bags.

### BRIEF SUMMARY OF THE INVENTION

The BAGMASTER is a removeable flexible, moisture resistant, adjustable, durable and reusable sleeve that inserts inside garden (and other) trash bags to facilitate the bags being filled and prevents, inhibits, the bags from being torn, ripped while being filled.

### BRIEF DESCRIPTION OF THE SEVERAL VIEWS OF THE DRAWING

Drawing 1 (Page 1/5) is a front view of the BAGMASTER that provides a front view with dimensions, it also shows the lines along which the material the BAGMASTER is made from is creased to allow it to be rolled up for storage. The view also shows the holes that are used to insert cord/string, with references to the drawings showing its installation, to be used to tie it closed when rolled up for storage. All dimensions in this drawing are in inches and the drawing is not to scale or in proportion.

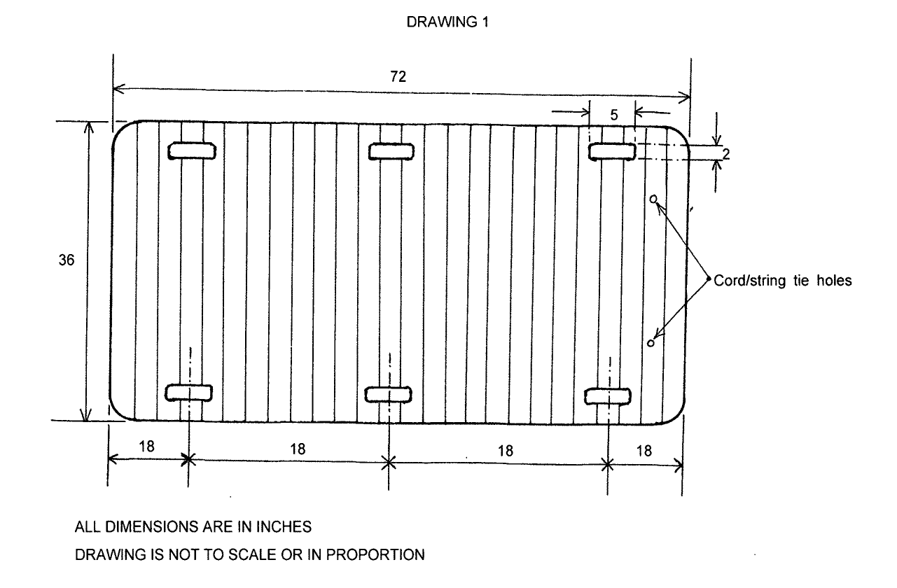

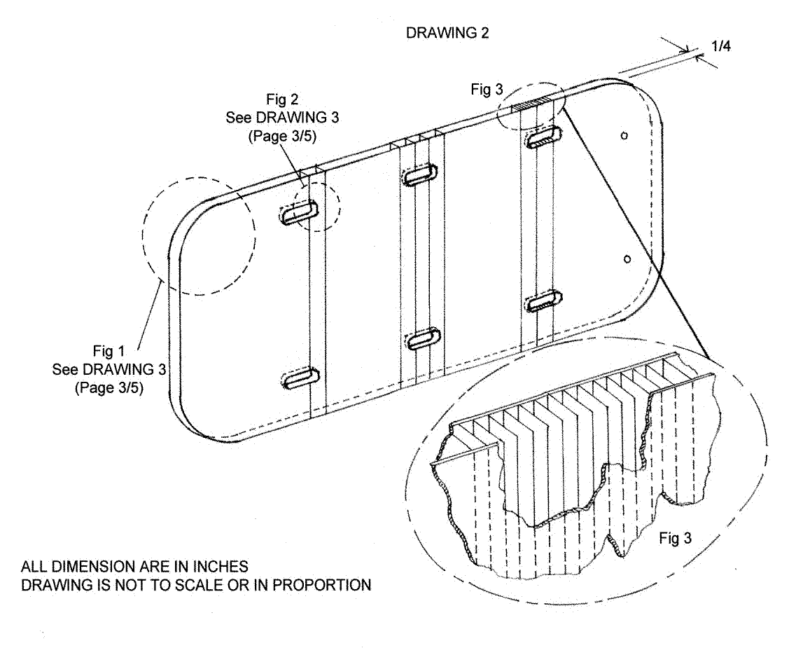

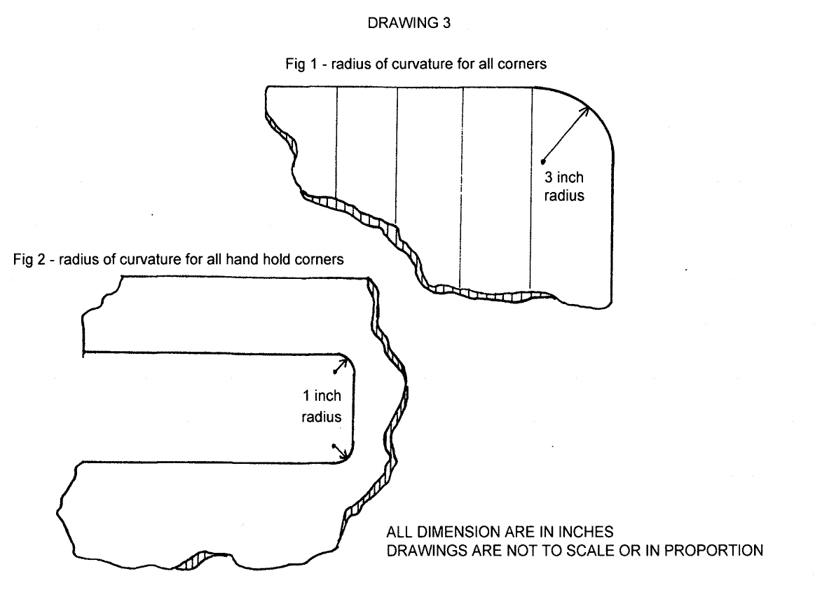

Drawing 2 (Page 2/5) is an isometric view of the BAGMASTER illustrating the corrugated nature of the material from which it is made. FIG. 3 provides detail of the channels in the materials corrugation. Also in this drawing there are references to Drawing 3 FIG. 1 and FIG. 2 which provide details of the curvature of the outer corners of the BAGMASTER and of the hand holds. All dimensions in this drawing are in inches and the drawing is not to scale or in proportion.

Drawing 3 (Page 3/5) comprises of FIG. 1 and FIG. 2 which show details of the curvature of the BAGMASTER outer corners (FIG. 1) and the hand holds (FIG. 2). FIG. 1 also has vertical lines showing the lines along which the material the BAGMASTER is made from is creased to allow it to be rolled up for storage. All dimensions in this drawing are in inches and the drawing is not to scale or in proportion.

Drawing 4 (Page 4/5) is a partial isometric view showing one corner and edge of the BAGMASTER giving details of where the tie holes are placed and the size of the tie holes. All dimensions in this drawing are in inches and the drawing is not to scale or in proportion.

Drawing 5 (Page 5/5) is a cross-section along Section A-A view of the tie hole with a cord/string inserted and tied in a knot on one side, both ties being installed and tied in the same manner with the knots on the same side of the corrugated plastic. All dimensions in this drawing are in inches and the drawing is not to scale or in proportion.

### DETAIL DESCRIPTION OF CONSTRUCTION

1. The BAGMASTER is constructed of corrugated plastic (Corriboard), COROPLAST or equal. (See: Drawing 2, FIG. 3) where the separation between the two sides is approximately ¼ inch (See: Drawing 2 and Drawing 5) or as dictated by material supply (allowing for the manufacturing tolerances of the fabricator of the board).

2. The BAGMASTER is designed to be symmetrical around its vertical and horizontal axis to simplify its use by avoiding a need to have it oriented in one direction when in service—it avoids a “this way up” preference when being used. (See: Drawing 1)

3. All four corners of the BAGMASTER are rounded with a radius of 3 inches (or another suitable radius as decided in manufacture) to mitigate the problem “square” corners would present—snagging the plastic of the garbage bag and possibly ripping it when the BAGMASTER is being placed inside. (See: Drawing 1 and Drawing 3, FIG. 1)

4. Handle hole openings are provided in the BAGMASTER to make moving a partially filled/filled garbage bag easier to pick up (to facilitate moving) Each corner of each handle hole has a radius of 1 inch (or another suitable radius as decided in manufacture) (See: Drawing 1 and Drawing 3, FIG. 2)

5. The corrugated plastic material used in the fabrication of the BAGMASTER is creased every 3. ½ inches (or another suitable dimension as decided in manufacture) along the lines of the materials internal corrugation channels to facilitate the BAGMASTER being fold-rolled up (See Drawing 1 and Drawing 3, FIG. 1).

6. Clips, Bulldog or similar, are provided to secure the garbage bag to the BAGMASTER (not shown in drawings)

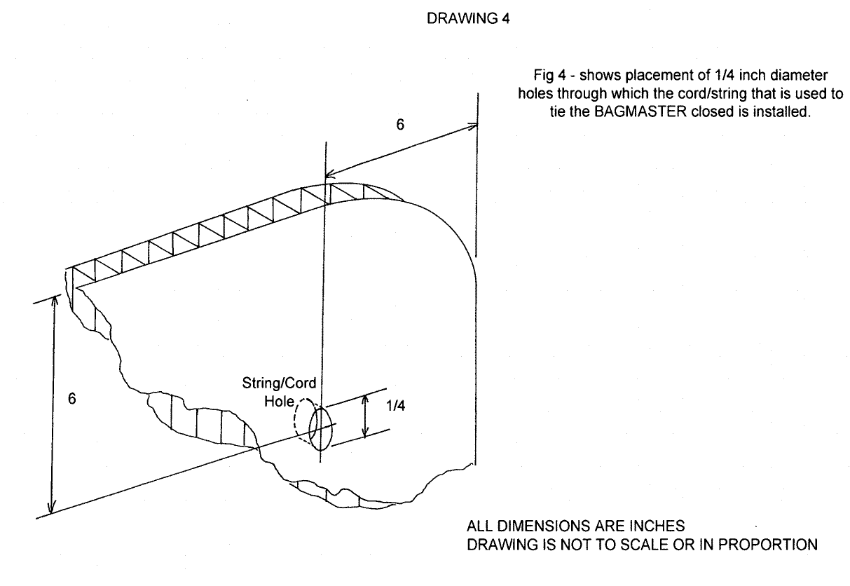

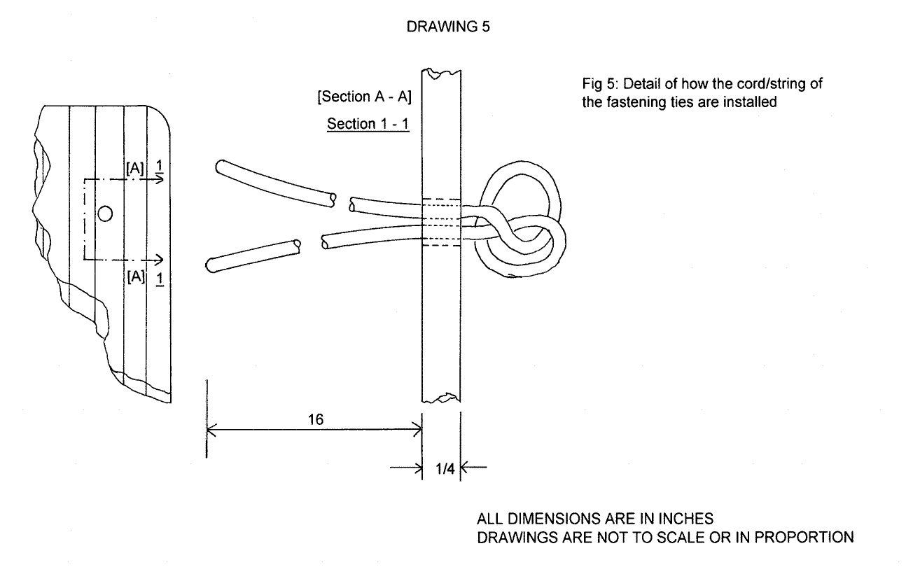

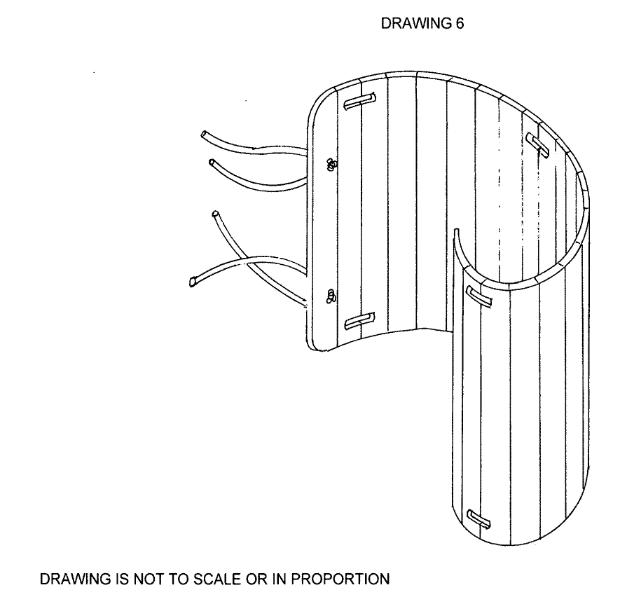

7. The BAGMASTER can be rolled up for storage, two “ties” using cord/string or equal are provided to keep the rolled up unit rolled up. To this end two holes are punched in suitable locations (See Drawing 4, FIG. 4) along one of the vertical (36 inch) edges of the BAGMASTER that will allow string/cord or equal be inserted, looped and tied (See Drawing 5, FIG. 5) as shown in Detail A-A

1. The BAGMASTER is a device that protects the integrity of the walls of plastic (or paper or similar) garbage bags from the inside inside. It is a water resistant, adjustable, variable diameter, re-usable cylindrical shaped sleeve that is temporarily (while a bag is being filled) placed inside inside a plastic (or paper or similar) trash bag to facilitate it being filled without the bag falling over, or its opening (mouth) closing as it is being filled while protecting it from being ripped. When the trash bag is full the BAGMASTER is removed for reuse.

2. A single sized BAGMASTER is capable of being used on a variety of sizes of plastic (or paper or similar) bags by varying the degree amount it is opened up, unrolled from its storage, rolled up, state.

3. The BAGMASTER is scalable in production to suit being used on a different range of sizes of plastic (or paper or similar) trash bags.
